(19) United States
(12) Patent Application Publication
(10) Pub. No.: US 2002/0152336 A1
(43) Pub. Date: Oct. 17, 2002

(54) System and method of installing a driver of an expansion card on a portable electronic device

(76) Inventor: Frank Tso, Taipei (TW)

Correspondence Address: BIRCH STEWART KOLASCH & BIRCH, PO BOX 747, FALLS CHURCH, VA, 22040-0747, US

(21) Appl. No.: 09/886,383

(22) Filed: Jun. 22, 2001

(30) Foreign Application Priority Data
Apr. 17, 2001 (TW) 90109208

(51) Int. Cl. G06F 3/00

(52) U.S. Cl. 710/8

(57) ABSTRACT

A system of installing a driver of an expansion card on a portable electronic device is disclosed. The system includes an expansion card receiving means, a driver storing means, a computer connecting means, a network connecting means and a driver manager. The expansion card receiving means receives an external expansion card. The driver storing means installed in the portable electronic device stores at least one driver. The computer connecting means provides means for the portable electronic device to connect to a computer device storing at least one driver. The network connecting means provides means for the portable electronic device to connect to a network. The driver manager automatically obtains a driver that can allow the expansion card operate normally from either the driver storing means, the computer device or the network. The invention also discloses a method for installing a driver of an expansion card on a portable electronic device conducted by the aforementioned system.

### BACKGROUND OF THE INVENTION

1. Field of Invention

The invention relates to a system and a method of installing a driver of an expansion card on a portable electronic device. In particular, it relates to a system and a method of installing a driver of an expansion card on a portable electronic device that can automatically obtain a driver, which allows the expansion card to operate normally.

2. Related Art

Owing to the progress in the electronic technology, portable electronic devices are becoming more and more popular. Taking the PDA (Personal Digital Assistant) as an example, it has various functions such as a calendar, an address book, a notebook, a calculator, a clock, games, etc. Lightweight and low priced, it attracts a lot of users.

Adding external accessories to the portable electronic device has become a popular method of expanding the functions of a portable electronic device. When a portable electronic device connects to an external device, the OS (Operating System) of the portable electronic device has to find a driver according to its type, model and version and install the driver in the portable electronic device in order to normally operate the external device. The driver has to be designed and provided to the user by the manufacturer of the external device.

Under certain circumstances, the driver of the external device can be directly obtained from the data storage device in the portable electronic device. When the driver cannot be directly obtained, the user has to, for example, download the driver for the external device from the website of the manufacturer using a PC (Personal Computer) and install it himself.

However, sometimes searching for drivers is very time-consuming. Users often waste a lot of time searching and installing drivers for new external devices on portable electronic devices. Some new users may even improperly install the drivers, resulting in disorder in the portable electronic device OS. This disorder may further render the portable electronic device and the external devices inoperable or damage them.

Thus, how to provide users a convenient system and method for installing drivers has become an important subject to be solved.

### SUMMARY OF THE INVENTION

It is an objective of the invention to provide a system for installing a driver of an expansion card on a portable electronic device, which can automatically search and install drivers for the user.

To achieve the above objective, the disclosed system of installing a driver of an expansion card on a portable electronic device includes an expansion card receiving means, a driver storing means, a computer connecting means, a network connecting means and a driver manager. The expansion card receiving means receives an external expansion card. The driver storing means installed in the portable electronic device stores at least one driver. The computer connecting means provides a means for the portable electronic device to connect to a computer device storing at least one driver. The network connecting means provides a means for the portable electronic device to connect to the Internet. The driver manager automatically obtains a driver that can allow the expansion card to operate normally from either the driver storing means, the computer device or the Internet.

The system can automatically search a driver that can allow the expansion card to function normally with the data storage device of the portable electronic device, the computer and the manufacturer website. The system then installs the driver so as to allow the expansion card to function normally. Therefore, the user does not need to manually search for the correct driver, thus saving a lot of time. In particular, it can help new users to conveniently install the drivers.

### BRIEF DESCRIPTION OF THE DRAWINGS

The invention will become more fully understood from the detailed description given hereinbelow illustration only, and thus are not limitative of the invention, and wherein:

FIG. 1 is a schematic view showing the structure of a PDA expansion driver installation system according to a preferred embodiment;

FIG. 2 is a schematic view showing the flowchart of a PDA expansion driver installation method according to a preferred embodiment; and

FIG. 3 is a schematic view showing the combination of a PDA expansion card driver installation system, a computer device, and a web server according to a preferred embodiment.

### DETAILED DESCRIPTION OF THE PREFERRED EMBODIMENT

The invention will be apparent from the following detailed description, which proceeds with reference to the accompanying drawings, wherein the same references relate to the same elements.

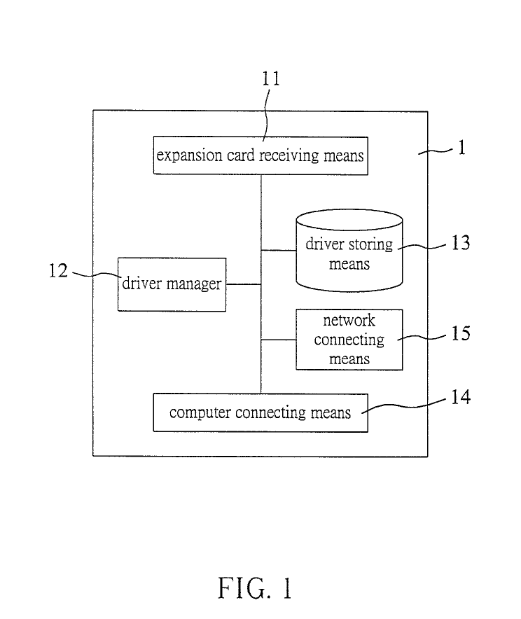

With reference to FIG. 1, the disclosed system of installing a driver of an expansion card in a portable electronic device is implemented in a portable electronic device 1. The portable electronic device includes an expansion card receiving means 11, a driver storing means 13, a computer connecting means 14, and a network connecting means 15. In the current embodiment, the portable electronic device 1 is a PDA. The PDA expansion card driver installation system includes at least a driver manager 12. The expansion card receiving means 11 receives an expansion card 50 to enhance the PDA functions. For example, the expansion card receiving means 11 can receive a CF (Compact Flash) memory card to enlarge the data storage capacity of the PDA. According to the currently available CF memory card products, the data storage amount of the CF memory cards can be 8 MB, 16 MB, 32 MB, 64 MB, and even as much as 340 MB. Therefore, they can greatly increase the PDA data storage capacity. Furthermore, the expansion card receiving means 11 can connect to the expansion card 50 of a PDA modem. Therefore, the PDA can have mobile online functions. Thus, the PDA network connection establishment does not require a mobile phone or a telephone.

The driver manager 12 provides drivers for the expansion card 50 on the expansion card receiving means 11 to function normally. In the embodiment, the driver manager 12 is a software module coded in Visual C++. Taking a PDA modem expansion card as an example, different PDA modem expansion cards made by different manufacturers use different drivers. Even the PDA modem expansion cards of different models made by the same manufacturer may use different drivers. Therefore, the driver manager 12 searches for the correct driver for the PDA modem expansion card on the expansion card receiving means 11.

The driver storing means 13 is installed in the PDA to store at least one driver. For example, the driver storing means 13 is a PDA memory installed in the PDA. The usual capacity of the PDA memory is 8 MB, which is sufficient for storing several drivers. Thus, the driver manager 12 can search the PDA memory to obtain a driver for the expansion card 50 to function normally. However, since the PDA memory capacity is limited and there are so many driver types, the PDA memory can store only a very few drivers.

The computer connecting means 14 enables the PDA to connect to a computer device 60, which stores at least one driver, so that the PDA can obtain the correct driver for the expansion card 50. For example, the computer connecting means 14 is a USB (Universal Serial Bus). The USB connects to one end of a synchronous transmission base and the other end of the synchronous transmission base connects to the connection port of a computer device 60. Therefore, the driver manager 12 can connect to the computer device 60 through the USB and search the computer device 60 to obtain the correct driver for the expansion card 50. A further example, if the computer connecting means 14 is an IR (infrared) transmission device, then PDA IR transmission device has to be used with the IR transmission device of the computer device 60. Thus, the driver manager 12 can search the computer device 60 to obtain the correct driver for the expansion card 50 via IR data transmission. In the current embodiment, the computer device 60 can further connect to the Internet. So the driver manager 12 connects to the computer device 60 via the computer connecting means 14 and obtains the correct driver for the expansion card 50 via the network.

The network connecting means 15 enables the PDA to connect to a network server storing at least one driver, for example, a LAN server or an Internet website, so as to obtain the correct driver for the expansion card 50 to function normally. For example, the network connecting means 15 is a mobile phone with network functions. Thus, the driver manager 12 connects directly to the Internet via the mobile phone and retrieves the correct driver for the expansion card 50 to function normally.

To make the content of the invention clearer, an example is described hereinafter to illustrate the method of installing a driver of a PDA expansion card.

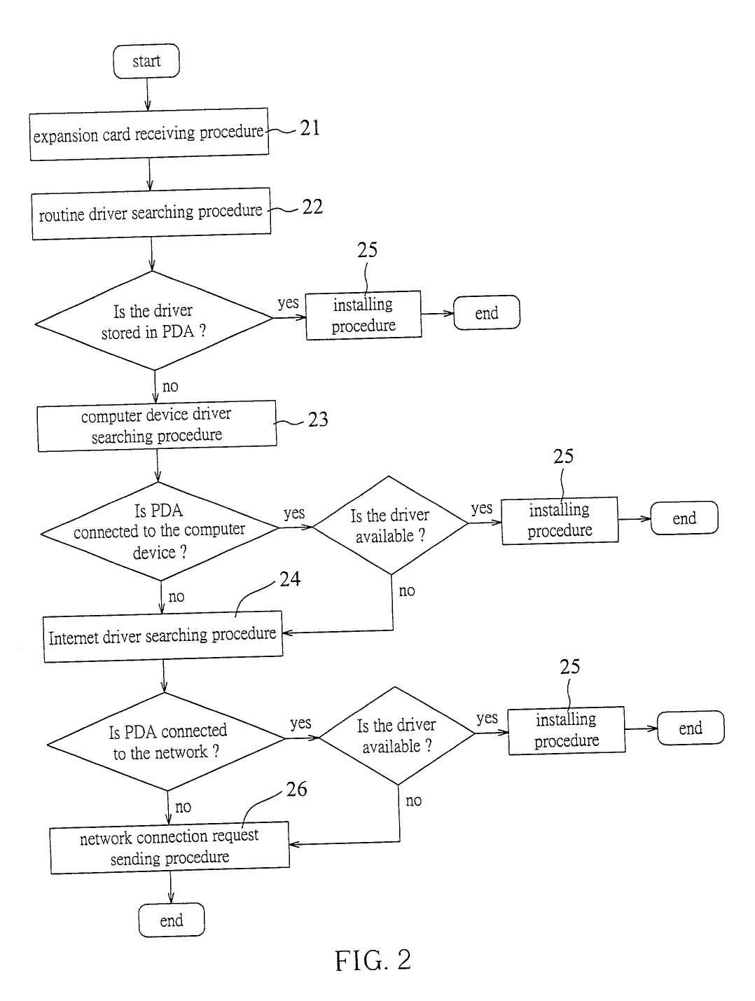

As shown in FIG. 2, the disclosed method 2 of installing a driver of a PDA expansion card includes an expansion card receiving procedure 21, a routine driver searching procedure 22, a computer device driver searching procedure 23, an Internet driver searching procedure 24, an installing procedure 25, and a network connection request sending procedure 26. The expansion card receiving procedure 21 receives an external expansion card 50 to enhance the functions of a PDA. The routine driver searching procedure 22 searches in the PDA for a correct driver for the expansion card 50 to function normally and determines whether the driver exists in the PDA. The computer device driver searching procedure 23 determines whether the PDA is connected to a computer device 60 and searches for a correct driver from the computer device 60 for the expansion card 50 to function normally when the PDA is connected to the computer device 60. The Internet driver searching procedure 24 determines whether the PDA is connected to the Internet and searches for a correct driver for the expansion card 50 to function normally over the Internet when the PDA is connected to Internet. The installing procedure 25 installs the found driver in the PDA. The following paragraphs explain the procedures in further detail.

In the expansion card receiving procedure 21, when the expansion card 50 is inserted into the expansion slot of the PDA, the PDA OS generates an interrupt signal. When the interrupt signal is produced, the routine searching procedure 22 is initiated to search for a driver according to the type (such as PCMCIA card, CF card, or memory stick), manufacturer, version, and serial number of the expansion card 50 from the PDA driver storing means 13. If the driver for the expansion card 50 is found, the installing procedure starts to install the driver in the PDA.

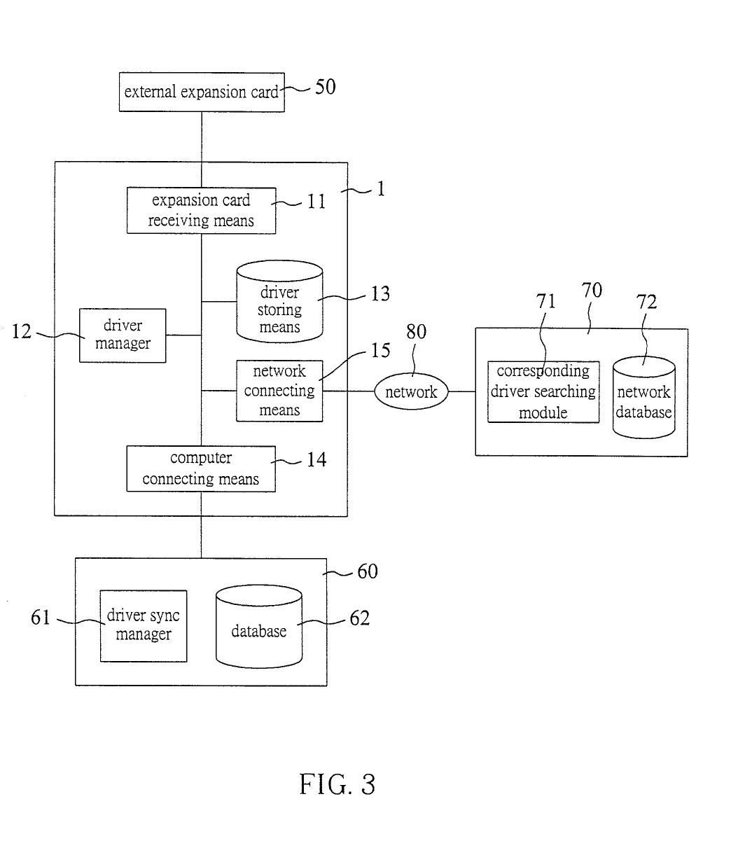

With reference to FIG. 3, if no usable driver is found in the driver storing means 13, then the driver manager 12 tries to obtain a connection with a driver sync manager 61 in the computer device 60 in the driver searching procedure 23. When the response of the driver sync manager 61 is received, then the driver manager 12 transmits the relevant data to the driver sync manager 61 of the computer device 60 so as to find a driver in the database 62 of the computer device 60. If the correct driver is found, then the driver is sent to the PDA and is installed by the driver manager 12.

With further reference to FIG. 3, if no correct driver can be found in both the PDA and the computer device 60, then the driver manager 12 tries to connect to a web server 70 through a network 80 (the Internet or a LAN) in the Internet driver searching procedure 24. In the procedure, if the PDA cannot establish a connection with the network 80, a message window is displayed on the PDA screen to ask the user to establish the connection between the PDA and the network in the network connection request sending procedure 26. After the PDA is connected to the network 80, the driver manager 12 tries to connect to the web server 70 so as to search for the correct driver in the web server 70. In this procedure, the PDA can use any method to establish a connection with the web server 70. For example, the PDA can use a PCMC1A card to dial up to the Internet and transmit data according to the TCP/IP protocol. The website of the web server 70 can be built into the driver manager 12 or put in by the user.

After receiving the search request from the PDA, the web server 70 uses a corresponding driver searching module 71 to find the driver in a network database 72 that satisfies all the requirements given in the data transmitted from the PDA. Thus, the user does not need to enter any additional information about the driver. When sending the search request, the PDA can simultaneously transmit the verification data, such as ID and password, needed for logging onto the web server 70 to verify the identity of the user. When the driver searching module 71 of the web server 70 finds the correct driver, the driver is sent back to the PDA through the network 80. After the PDA gets the driver, the driver manager 12 starts the installation procedure 25.

Through the above-mentioned procedure, the PDA can automatically search the driver for an expansion card from the PDA driver storing means, a computer database, and the network database of a web server, and complete the installation procedure. This method can thus achieve the plug-and-play feature. The user does not need to manually search for the correct driver for the expansion card.

It should be noted that the order of the computer device driver searching procedure 23 and the Internet driver searching procedure 24 is not necessarily fixed. One can also perform the Internet driver searching procedure 24 before the computer device driver searching procedure 23. Both of them can be considered together as an external driver searching procedure and can use any other proper means to search for drivers from an external source.

While the invention has been described by way of example and in terms of the preferred embodiment, it is to be understood that the invention is not limited to the disclosed embodiments. To the contrary, it is intended to cover various modifications and similar arrangements as around be apparent to those skilled in the art. Therefore, the scope of the appended claims should be accorded the broadest interpretation so as to encompass all such modifications and similar arrangements.

What is claimed is:

1. A system of installing a driver of an expansion card on a portable electronic device, comprising:
an expansion card receiving means for receiving an external expansion card;
a driver storing means installed in the portable electronic device for storing at least one driver;
a computer connecting means for enabling the portable electronic device to connect to a computer device that stores at least one driver;
a network connecting means for enabling the portable electronic device to connect to a network; and
a driver manager, which automatically obtains an driver that allows the expansion card in the expansion card receiving means to function normally via one of the driver storing means, the computer connecting means, and the network connecting means.

2. The system of claim 1, wherein the driver manager first searches for the correct driver that allows the expansion card to function normally in the driver storing means and, when no correct driver can be found in the driver storing means, automatically connects to the computer device through the computer connecting means to find the driver that allows the expansion card to function normally.

3. The system of claim 1, wherein the driver manager first searches for the correct driver that allows the expansion card to function normally in the driver storing means and, when no correct driver can be found in the driver storing means, automatically connects to the network through the network connecting means to find the driver that allows the expansion card to function normally.

4. The system of claim 1, wherein the expansion card is a CF (Compact Flash) card.

5. The system of claim 1, wherein the portable electronic device is a PDA (Personal Digital Assistant).

6. The system of claim 1, wherein the driver storing means is a memory device.

7. The system of claim 1, wherein the computer connecting means is a USB (Universal Serial Bus).

8. The system of claim 1, wherein the computer connecting means is an IR (Infrared) transmission means.

9. The system of claim 1, wherein the computer device further connects to the network in order to obtain at least one driver from the network.

10. The system of claim 1, wherein the network connecting means connects to the network via a mobile communications device.

11. The system of claim 1, wherein the network connecting means connects to the network via a modem.

12. The system of claim 1, wherein the network is the Internet

13. A method of installing a driver of an expansion card on a portable electronic device, comprising:
a routine driver searching procedure, which automatically obtains a driver that allows the expansion card to function normally from a driver storing means; and
an external driver searching procedure, which automatically obtains the driver that allows the expansion card to function normally from a computer device and a network when the routine driver searching procedure cannot find the driver in the driver storing means.

14. The method of claim 13, wherein the external driver searching procedure comprises:
a computer device driver searching procedure, which automatically searches for the driver in the computer device; and
an network driver searching procedure, which automatically searches for the driver in a web server via the network.

15. The method of claim 13, further comprising:
a network connection request sending procedure, which sends out a request for a connection between the portable electronic device and the network when the portable electronic device and the network cannot successfully establish a connection.

16. The method of claim 13, wherein the expansion card is a CF (Compact Flash) card.

17. The method of claim 13, wherein the portable electronic device is a PDA (Personal Digital Assistant).

18. The method of claim 13, wherein the driver storing means is a memory device.

19. The method of claim 13, wherein the network is the Internet.
